(19) United States
(12) Patent Application Publication
(10) Pub. No.: US 2007/0220262 A1
(43) Pub. Date: Sep. 20, 2007

(54) Input assisting apparatus, input assisting method, and computer product

(75) Inventors: Shigenari Suzuki, Kawasaki (JP); Kazufumi Nara, Kawasaki (JP); Kaoru Ota, Kawasaki (JP); Kazunori Nomura, Kawasaki (JP); Naoshi Nakagawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/522,398

(22) Filed: Sep. 18, 2006

(30) Foreign Application Priority Data
Mar. 6, 2006 (JP) 2006-059578

(51) Int. Cl. H04L 9/00

(52) U.S. Cl. 713/176

(57) ABSTRACT

An input assisting apparatus assists an input from a user. An input receiving unit receives the input from the user. An input-verification-data creating unit creates input verification data based on contents of the input received by the input receiving unit.

### BACKGROUND OF THE INVENTION

1. Field of the Invention

The present invention relates to a technology for preventing an input error of a user.

2. Description of the Related Art

There have been technologies in the past to prevent input errors committed by users. The technology disclosed in Japanese Patent Application Laid-Open No. H6-176024, for example, involves preventing incorrect input of commands by determining whether a plurality of data editing commands can be executed in succession.

Another technology disclosed in Japanese Patent Application Laid-Open No. H5-108568 and which is applied in situations where there are repeated entries of command names involves sorting a registration table in a descending order of an input frequency of the command names, and setting low priority to commands with high input frequency.

However, the conventional technologies do not support input of non-successive commands or commands with low usage frequency, and therefore lack versatility.

Further, typographic errors, such as the one arising from mistaking the alphabet “l” for the numeral “1”, and vice versa, are hard to detect. Such errors are especially common when the user is entering data while referring to a printed document. Thus, there is a need for a technology for assisting a user while inputting data which is versatile and which can easily verify any input errors.

### SUMMARY OF THE INVENTION

It is an object of the present invention to at least partially solve the problems in the conventional technology.

An input assisting apparatus according to one aspect of the present invention assists an input from a user. The input assisting apparatus includes an input receiving unit that receives the input from the user; and an input-verification-data creating unit that creates input verification data based on contents of the input received by the input receiving unit.

A computer-readable recording medium according to another aspect of the present invention stores therein a computer program for assisting an input from a user. The computer program causes a computer to execute receiving the input from the user; and creating unit input verification data based on contents of the input received at the receiving.

An input assisting method according to still another aspect of the present invention is for assisting an input from a user. The input assisting method includes receiving the input from the user; and creating unit input verification data based on contents of the input received at the receiving.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a concept of an embodiment of the present invention;

FIG. 2 is a schematic diagram of a procedure-manual creating device;

FIG. 3 is a schematic for explaining procedure manual creation;

FIG. 4 is a schematic for explaining procedure manual creation (continuation of FIG. 3);

FIG. 5 is a schematic for explaining a procedure manual;

FIG. 6 is a flowchart of an operation performed by the procedure-manual creating device shown in FIG. 2;

FIG. 7 is a schematic diagram of an operation executing device;

FIG. 8 is a schematic for explaining operation execution;

FIG. 9 is a schematic for explaining operation execution (continuation of FIG. 8); and

FIG. 10 is a flowchart of an operation performed by the operation executing device shown in FIG. 7.

### DETAILED DESCRIPTION OF THE PREFERRED EMBODIMENTS

Exemplary embodiments of the present invention are described below in detail with reference to the accompanying drawings.

According to an embodiment of the present invention, a printed procedure manual containing the commands in the sequence in which they ought to be input by a user executing the operation (an operation executor) is created in advance so that the operation executor can input the commands by referring to the procedure manual.

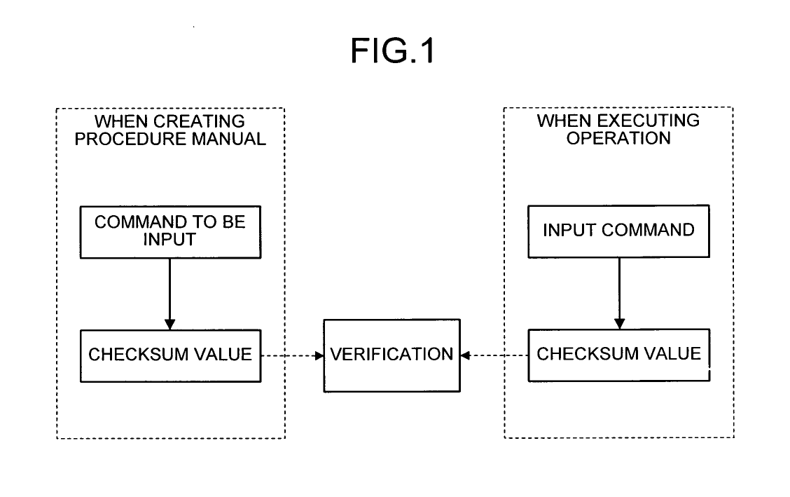

When creating the procedure manual, input verification data is created from the commands to be input, as shown in FIG. 1. The input verification data is uniquely determined the commands to be input, and should have sufficiently fewer characters than the command strings of the original commands. In FIG. 1, a checksum calculated from the command strings of the commands to be input is considered as the input verification data.

A checksum pertains to a technology that is used for detecting communication errors. Specifically, when data is transmitted, the data is broken down into uniform blocks of bits, a numerical value is assigned to represent the data in each block, the numerical values of all the blocks are added, and a value is determined as a checksum value by subjecting the sum to a certain calculation. The calculated checksum value is attached to the data and transmitted along with the data. The receiving device compares an operation result obtained by a similar calculation and the checksum value to detect any errors.

According to the present embodiment, the checksum value is used as the input verification data corresponding to the commands to be input. In other words, by printing the checksum values along with the commands to be input by the operation executor, and calculating the checksum values from the commands input by the operation executor, the present embodiment enables the operation executor to easily verify whether the commands input by himself/herself is correct by verifying the checksum values printed on the procedure manual against the displayed checksum values.

The present embodiment enables detection of an input error arising from entering a wrong character from the checksum value, as the checksum values, which are calculated from the command strings, will be different if there is any change in the command string. For example, similar looking characters such as the alphabet “l” and the numeral “1” in the command string can be mistaken for each other by the operation executor. However, the resulting wrong input can be promptly detected from the checksum values. Further, the error detection according to the present embodiment is not dependent on the usage frequency of the commands or whether the commands are successive, accounting for its versatility.

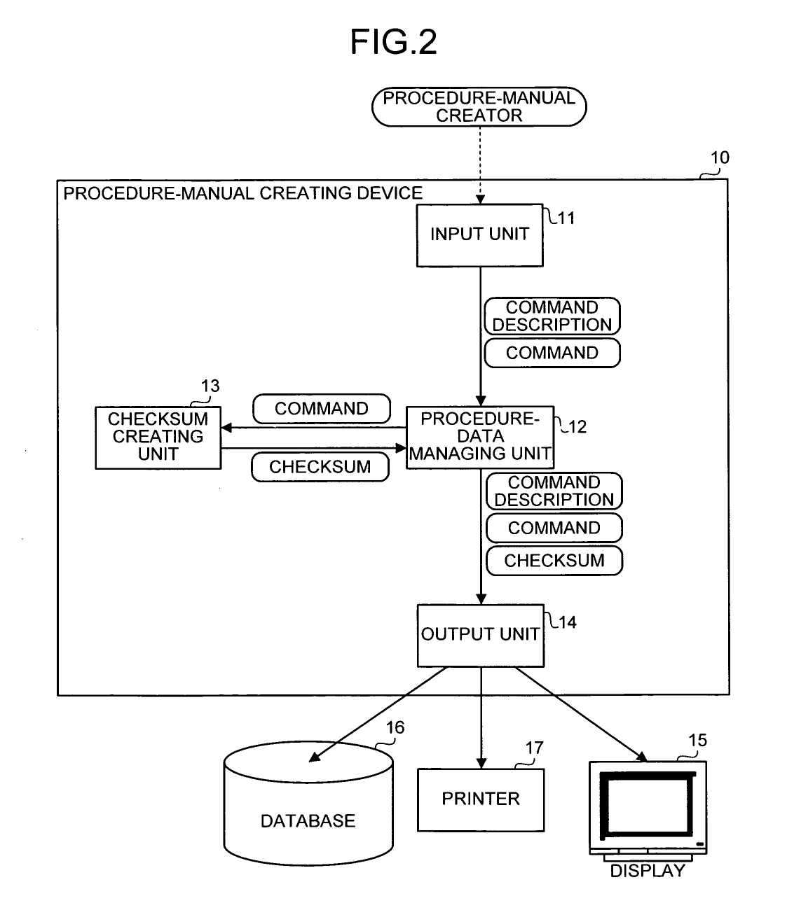

The creation of the procedure manual and execution of operation are explained below in detail. FIG. 2 is a schematic diagram of a procedure-manual creating device 10 that creates the procedure manual. The procedure-manual creating device 10 includes an input unit 11, a procedure-data managing unit 12, a checksum creating unit 13, and an output unit 14.

The input unit 11 accepts input from a user who creates the procedure manual (a procedure-manual creator), and specifically constitutes a keyboard, mouse, a touch panel, etc.

The procedure-data managing unit 12 manages data related to the procedure accepted by the input unit 11, and creates the content of the procedure manual. As soon as the input unit 11 accepts the input of the command and the command description from the procedure-manual creator, the procedure-data managing unit 12 outputs the command to the checksum creating unit 13.

The checksum creating unit 13 calculates the checksum value by executing a predetermined calculation on the command string of the command received from the procedure-data managing unit 12, and returns the checksum value to the procedure-data managing unit 12.

The procedure-data managing unit 12 associates the command description and the checksum value with the command, and if there are inputs of further commands, manages their sequence, and forwards the commands to the output unit 14 as required. The output unit 14 displays the procedure manual on a display 15, or stores the procedure manual in an external database 16, or takes a print output of the procedure manual from a printer 17.

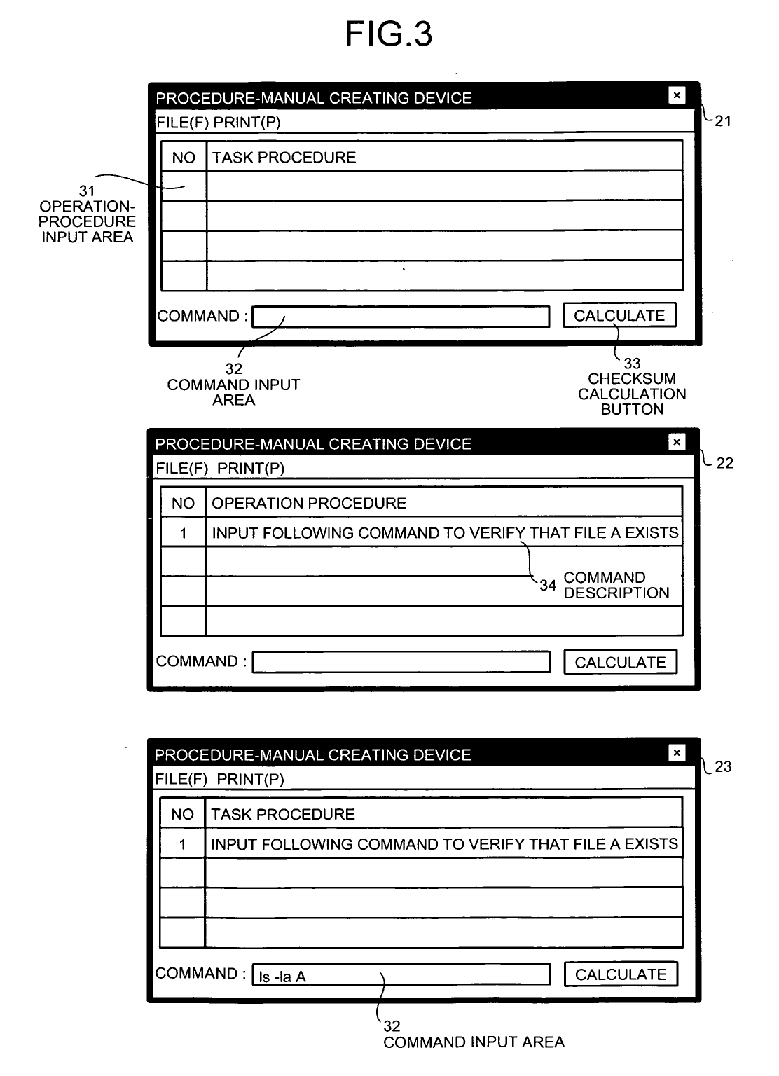

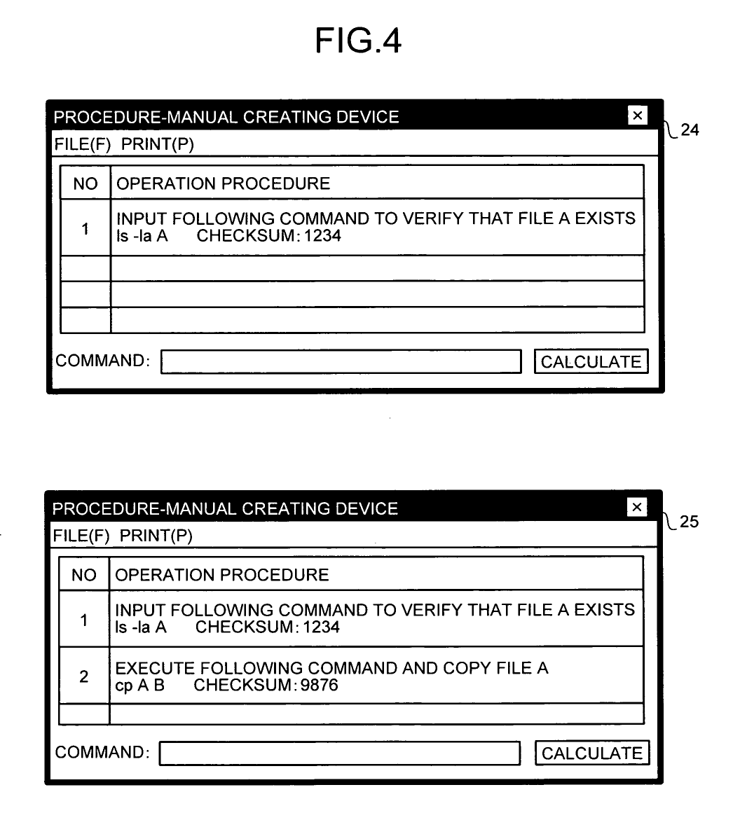

The procedure-manual creation is described in further detail with reference to FIG. 3 and FIG. 4. FIG. 3 is a drawing of a screen 21 displayed on the display 15. The screen 21 includes an operation-procedure input area 31, a command input area 32, and a checksum calculation button 33.

The description of the operation procedure, that is, a command description 34, entered by the procedure-manual creator is displayed in the operation-procedure input area 31. The procedure-manual creator then enters a command “ls-la A” in the command input area 32 and clicks the checksum calculation button 33. The checksum value is calculated from the command strings of the command and, as shown in a screen 24, the command “ls-la A” and its corresponding checksum value of 1234 are displayed in the operation-procedure input area 31.

A screen 25 displays the next command “cp A B” and the description entered by the procedure-manual creator, and the checksum 9876 calculated from the command description and the command “cp A B”.

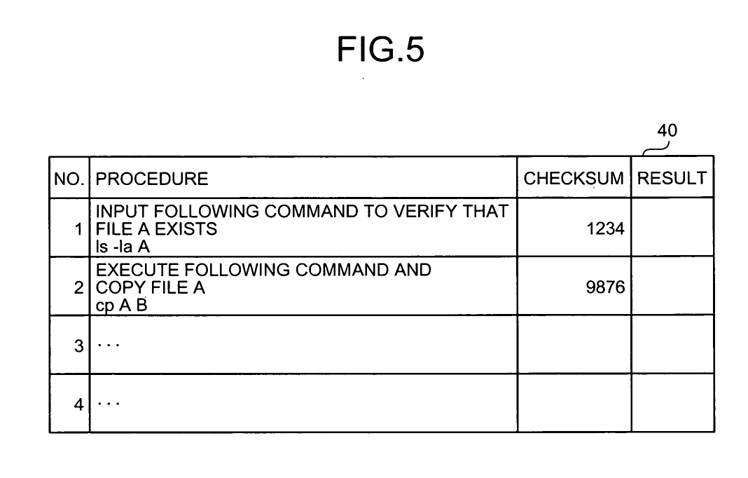

Thus, by sequential input of the commands and their descriptions by the procedure-manual creator, a procedure manual containing the checksum value of each command is created. When the procedure-manual creator enters a Print command, a procedure manual 40 as shown in FIG. 5 is printed out.

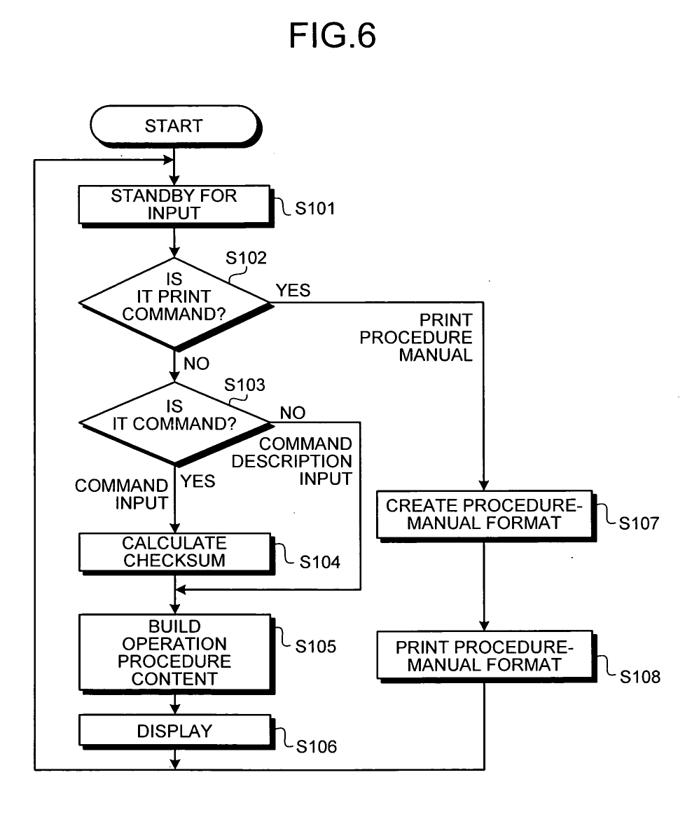

FIG. 6 is a flowchart of an operation performed by the procedure-manual creating device 10. On starting up, the procedure-manual creating device 10 goes into a standby mode, ready to accept an input from the procedure-manual creator (step S101).

When an input from the procedure-manual creator is accepted by the input unit 11, the procedure-data managing unit 12 assesses whether the input is a Print command for printing the procedure manual (step S102). If the input is not a Print command (No at step S102), the procedure-data managing unit 12 assesses whether the next input is a command (step S103).

If the next input is not a command (No at step S103), the content of the input is stored in the procedure content as command description (step S105), and if the next input is a command (Yes at step S103), the checksum creating unit 13 calculates the checksum from the character string of the command (step S104), and stores the checksum in the procedure content (step S105).

The output unit 14 displays the procedure content built up based on the input on the display 15 (step S106). Thereafter, the procedure-manual creating device 10 returns to a standby mode (step S101).

If the input accepted by the input unit 11 is a Print command (Yes at step S102), the procedure-data managing unit 12 creates a print format of the procedure manual (step S107), and gives a print output of the procedure content in the created format (step S108). Thereafter, the procedure-manual creating device 10 returns to a standby mode (step S101).

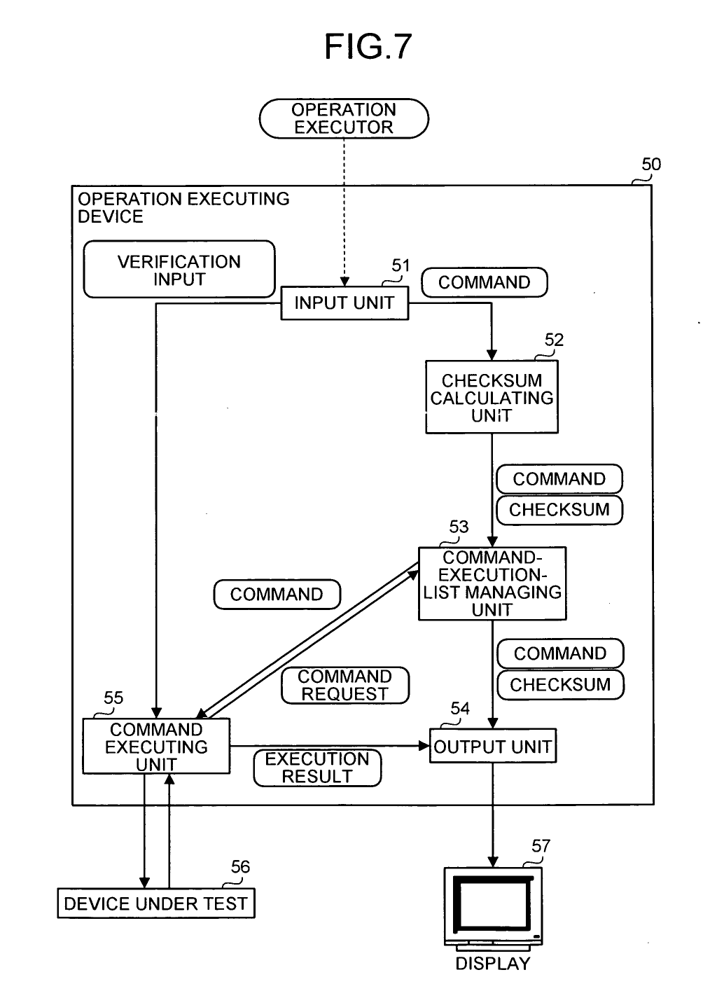

The execution of operation based on the procedure manual is explained in detail below. FIG. 7 is schematic diagram of an operation executing device 50 that executes operations, specifically the operations executed by inputting commands into a device under test. The operation executing device 50 is connected to a device under test 56 and a display 57, and includes an input unit 51, a checksum calculating unit 52, a command-execution-list managing unit 53, an output unit 54, and a command executing unit 55.

The input unit 51 accepts input from the user who executes the operations be referring to the procedure manual (the operation executor). If the input accepted from the operation executor is a command, the input unit 51 outputs the command to the checksum calculating unit 52, and if the input accepted from the operation executor is a directive to execute or cancel a command, the input unit 51 outputs the directive to the command executing unit 55. The input unit 51 specifically constitutes a keyboard, mouse, a touch panel, etc.

The checksum calculating unit 52 calculates the checksum from the character string of the command input via the input unit 51, and attaches the calculated checksum value to the command, and sends it to the command-execution-list managing unit 53. The command-execution-list managing unit 53 stores the command and the checksum received from the checksum calculating unit 52, as well as outputs the same to the output unit 54.

Upon receiving a directive to execute the command from the input unit 51, the command executing unit 55 retrieves the command stored by the command-execution-list managing unit 53, inputs the retrieved command into the device under test 56, and receives the execution result. The command executing unit 55 then outputs the execution result to the output unit 54. If the input received from the input unit 51 is a directive to cancel the command, the command executing unit 55 cancels the command stored in the command-execution-list managing unit 53.

The output unit 54 controls the display output on the display 57, and displays on the display 57 the command and the checksum value received from the command-execution-list managing unit 53, the execution result received from the command executing unit 55, etc.

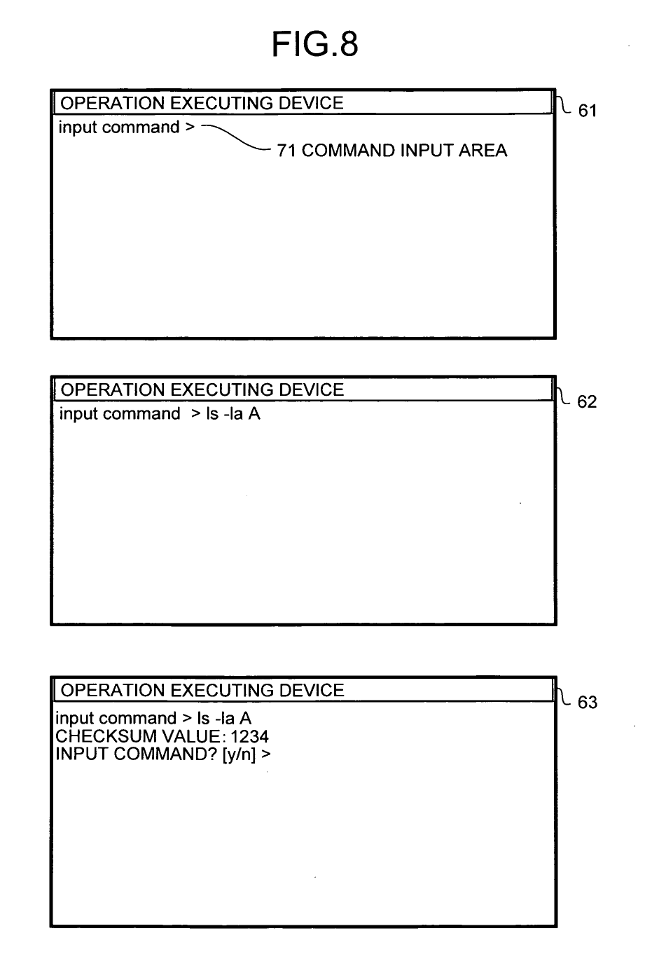

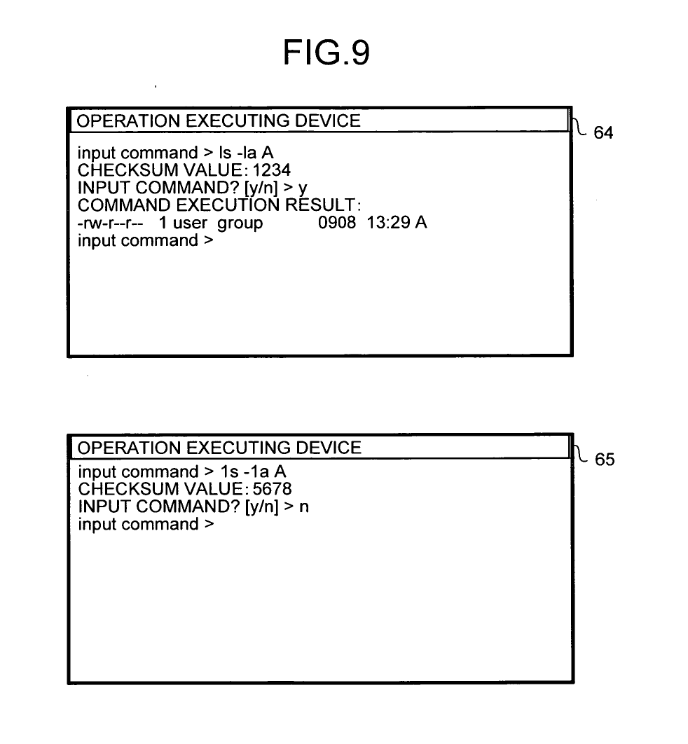

Operation execution is explained in detail below with reference to FIG. 8 and FIG. 9. FIG. 3 is a drawing of a Screen 61 displayed on the display 57. The screen 61 includes a command prompt followed by a command input area 71.

As shown in FIG. 8, when the command “ls-la A” is entered in the command input area 71 by the operation executor, a checksum value is calculated from the character string of the command, and as shown in a screen 63, the checksum value 1234 corresponding to the input command “ls-la A” and a query “Input command?[y/n]” as to whether the command is to be input or canceled are displayed.

The operation executor then verifies the checksum value displayed on the display 57 against the checksum value printed on the procedure manual, and input “y” if the two are the same. The command executing unit 55 then receives a directive to execute the command, executes the command, and displays the execution result in a screen 64.

However, if the operation executor misreads and enters the numeral “1” in place of the alphabet “1” in the command, as shown in a screen 65, the checksum calculating unit 52 a checksum value of 5678 from the input command “1s-1a A”. Thus, even if the input seems to be correct at first glance because of the characters, such as 1 and l, bearing resemblance to each other, the operation executor can easily realize the input error by comparing the checksum value calculated from the incorrect input with the checksum value obtained from the correct input.

Upon receiving the directive “n” for the query “Input command? [y/n]” received as an input from the operation executor on realizing the input error, the command executing unit 55 cancels the execution of the command. A command prompt is displayed on the display 57.

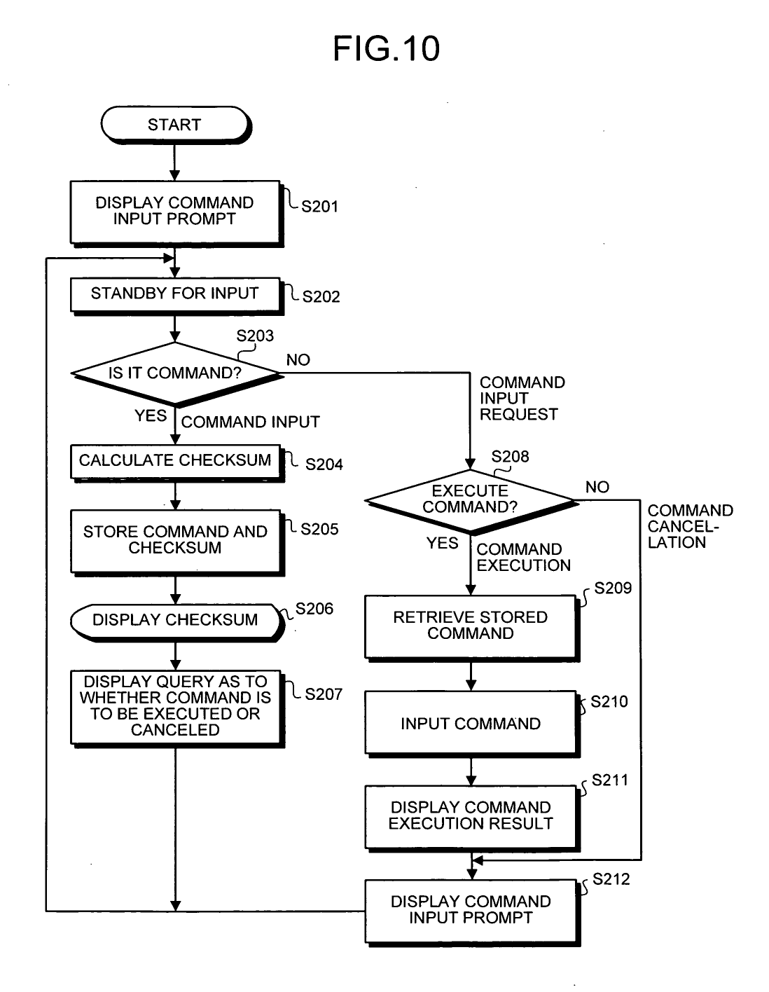

FIG. 10 is a flowchart of an operation performed by the operation executing device 50. On starting up, the operation executing device 50 displays a command prompt (step S201), and goes into a standby mode, ready to accept an input from the operation executor (step S202).

Upon receiving an input from the operation executor, the input unit 51 assesses whether the input is a command (step S203). If the input is a command (Yes at step S203), the checksum calculating unit 52 calculates the checksum from the character string of the command (step S204), and the command-execution-list managing unit 53 stores the command and the checksum (step S205).

The display 57 displays the checksum (step S206) as well as a query as to whether the command is to be input or canceled (step S207), and the operation executing device 50 returns to a standby mode (step S202).

If the input accepted by the input unit 51 is not a command (No at step S203), the command executing unit 55 assesses whether the input is a directive to execute the command (step S208). If the input is not a directive to execute the command but is a directive to cancel the command (No at step S208), the command executing unit 55 cancels the command, and displays a command prompt on the display 57 (steps S212). The operation executing device 50 returns to a standby mode.

If the input received by the input unit 51 is a directive to execute the command (Yes at step S208), the command executing unit 55, retrieves the command stored by the command-execution-list managing unit 53 (step S209), and inputs the retrieved command into the device under test 56 (step S210).

The display 57 displays the execution result of the command (step S211). Thereafter, the display 57 displays the command prompt (step S212), and returns to a standby mode (step S202).

Thus, the procedure-manual creating device 10 according to the present embodiment calculates and prints the checksum from the character strings when creating the procedure manual and the operation executing device 50 according to the present embodiment calculates and displays the checksum from the command being input when the operation is being executed. Consequently, the operation executor can verify the checksum value printed in the procedure manual against the displayed checksum value, and easily check whether the command input by the operation executor is correct.

According to the present embodiment, checksum is used as the input verification data. However, a value, such as parity bit and checkbit, which can be obtained using any method from the character string being input can be used as the input verification data.

Furthermore, according to the present embodiment, the procedure creation and the operation execution are performed by dedicated devices. A single device may be used for both procedure creation and operation execution.

Further, the procedure-manual creating device 10 and the operation executing device 50 are explained above as hardware. However, they can be implemented as software. In other words, a computer program can be executed on a computer system the same functions as the procedure-manual creating device 10 and the operation executing device 50.

According to an embodiment of the present invention, the input assisting apparatus, upon receiving an input from a user, creates input verification data based on the input content. Consequently, the user can verify from the input verification data whether the input content is correct.

Furthermore, according to an embodiment of the present invention, the input assisting apparatus, upon receiving an input from the user, performs a predetermined operation on the input content, and uses the operation result as the input verification data. Consequently, a highly versatile input assisting apparatus is obtained that enables the user to verify the correctness of the any kind of input content.

Moreover, according to an embodiment of the present invention, the input assisting apparatus creates an input procedure manual which contains, in a correlated form, a plurality of input content to be input in a predetermined sequence and a plurality of input verification data corresponding to the input content. Consequently, a procedure manual can be created that prevents the user from committing input errors.

Furthermore, according to an embodiment of the present invention, the input assisting program, upon receiving an input from a user creates input verification data based on the input content. Consequently, the user can verify from the input verification data whether the input content is correct.

Moreover, according to an embodiment of the present invention, the input assisting method, upon receiving an input from a user creates input verification data based on the input content. Consequently, the user can verify from the input verification data whether the input content is correct.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input assisting apparatus that assists an input from a user, the input assisting apparatus comprising:
an input receiving unit that receives the input from the user; and
an input-verification-data creating unit that creates input verification data based on contents of the input received by the input receiving unit.

2. The input assisting apparatus according to claim 1, further comprising:
an output unit that outputs the input verification data in a visible form.

3. The input assisting apparatus according to claim 1, wherein
the input receiving unit receives an input of a command, and
the input-verification-data creating unit creates the input verification data corresponding to the command.

4. The input assisting apparatus according to claim 1, wherein
the input-verification-data creating unit performs a predetermined operation on the contents of the input, and outputs a result of the operation as the input verification data.

5. The input assisting apparatus according to claim 4, wherein
the input-verification-data creating unit calculates a checksum of the contents of the input, and outputs a value of the checksum as the input verification data.

6. The input assisting apparatus according to claim 1, further comprising:
a procedure-manual creating unit that creates an input procedure manual that contains a plurality of input contents to be input in a predetermined sequence and a plurality of input verification data corresponding to the input contents, respectively, in a corresponding manner.

7. The input assisting apparatus according to claim 3, further comprising:
a command executing unit that, when the input is a command, executes the command.

8. The input assisting apparatus according to claim 4, further comprising:
a command executing unit that, when the input is a command, executes the command.

9. The input assisting apparatus according to claim 6, further comprising:
a command executing unit that, when the input is a command, executes the command.

10. The input assisting apparatus according to claim 7, further comprising:
a command-execution managing unit that, when the command is input, displays input verification data corresponding to the command, and requests for an instruction to execute the command.

11. The input assisting apparatus according to claim 8, further comprising:
a command-execution managing unit that, when the command is input, displays input verification data corresponding to the command, and requests for an instruction to execute the command.

12. The input assisting apparatus according to claim 9, further comprising:
a command-execution managing unit that, when the command is input, displays input verification data corresponding to the command, and requests for an instruction to execute the command.

13. A computer-readable recording medium that stores therein a computer program for assisting an input from a user, wherein
the computer program causes a computer to execute:
receiving the input from the user; and
creating unit input verification data based on contents of the input received at the receiving.

14. An input assisting method of assisting an input from a user, the input assisting method comprising:
receiving the input from the user; and
creating unit input verification data based on contents of the input received at the receiving.

15. The input assisting method according to claim 14, further comprising:
creating an input procedure manual containing a plurality of input contents to be input in a predetermined sequence and a plurality of input verification data corresponding to the input contents, respectively, in a corresponding manner.

16. The input assisting method according to claim 14, further comprising:
executing, when the input is a command, the command.
